(19) United States
(12) Patent Application Publication
(10) Pub. No.: US 2015/0251325 A1
(43) Pub. Date: Sep. 10, 2015

(54) Electric Hair Trimmer

(71) Applicant: Spectrum Brands, Inc., Middleton, WI (US)

(72) Inventors: Daniel R. Teteak, Madison, WI (US); David Toy, Middleton, WI (US)

(21) Appl. No.: 14/638,195

(22) Filed: Mar. 4, 2015

Related U.S. Application Data
(60) Provisional application No. 61/947,848, filed on Mar. 4, 2014.

(51) Int. Cl. B26B 19/06; B08B 9/00; B08B 3/04; B26B 19/14; B26B 19/40

(52) U.S. Cl. CPC B26B 19/06; B26B 19/148; B26B 19/40; B08B 3/04; B08B 9/00

(57) ABSTRACT

An electric trimmer has a handle, a motor, and a trimmer head extending at least in part longitudinally from the handle. The head has a housing and an elongate blade assembly including at least one reciprocating blade that reciprocates at least in part longitudinally. The housing has an inlet port for receiving cleaning fluid into the housing other than between the blade assembly and housing. The housing defines an internal flow path in flow communication with the inlet port and extending at least in part longitudinally of within the housing for directing cleaning fluid to flow at least in part longitudinally within the housing.

### CROSS REFERENCE TO RELATED APPLICATION

This application claims priority to Provisional Patent Application Ser. No. 61/947,848, filed on Mar. 4, 2014, which is incorporated herein by reference in its entirety.

### BACKGROUND

The present invention relates generally to grooming appliances and, more particularly, to electric hair trimmers.

Many conventional electric hair trimmers include a blade housing that supports (or at least partially surrounds) a blade assembly. Because hair and other debris may collect in the blade housing and on the blade assembly throughout the life of the trimmer, it is desirable to periodically clean the blade housing and the blade assembly to facilitate ensuring that the trimmer continues to operate smoothly and remains hygienic. As such, it would be useful to provide a trimmer for which the blade assembly and the blade housing are easily and effectively washable.

### SUMMARY

In one embodiment, an electric trimmer generally comprises a handle, a motor housed within the handle and a trimmer head extending at least in part longitudinally from the handle. The trimmer head has a housing and an elongate blade assembly retained by the housing, with the blade assembly including at least one reciprocating blade operatively connected to the motor and oriented for reciprocating at least in part longitudinally. The trimmer head housing has an inlet port through which cleaning fluid can enter the housing other than between the blade assembly and the housing. The housing defines an internal flow path in flow communication with the inlet port and extending at least in part longitudinally of the housing for directing fluid to flow at least in part longitudinally within the housing.

In another embodiment, a detachable trimmer head for an electric trimmer having a handle that contains a motor generally comprises a housing and an elongate blade assembly retained by the housing, with the blade assembly including at least one reciprocating blade operatively connected to the motor and oriented for reciprocating at least in part longitudinally. The trimmer head housing has an inlet port through which cleaning fluid can enter the housing other than between the blade assembly and the housing. The housing defines an internal flow path in flow communication with the inlet port and extending at least in part longitudinally of the housing for directing fluid to flow at least in part longitudinally within the housing.

In yet another embodiment, a method of cleaning an ear and nose trimmer generally comprises directing cleaning fluid to flow into an interior of the trimmer head housing adjacent a proximal end of the housing and other than between a blade assembly and the housing. Cleaning fluid is then directed to flow along an internal flow path within the interior of the trimmer head housing from the proximal end toward the distal end of the housing. At least some of cleaning fluid is directed to flow outward of the housing between the blade assembly and the housing to thereby clean the blade assembly. The remaining cleaning fluid is directed to flow outward of the housing at the distal end of the housing other than between the blade assembly and the housing.

In yet another embodiment, an electric grooming appliance generally comprises a handle, a motor housed within the handle, and a head extending from the handle. The head has a housing, a hair removal device contained partially within the housing, and an opening in the housing through which the hair removal device is exposed for removing hair. The hair removal device includes at least one movable hair removing member. The appliance further includes an inlet port and an outlet port that are each defined on one of the head and the handle, and an internal flow path that extends from the inlet port to the outlet port in flow communication with the opening such that a cleaning fluid can flow through the internal flow path to clean the hair removal device by entering and exiting the appliance other than through the opening by which the hair removal device is exposed.

### BRIEF DESCRIPTION

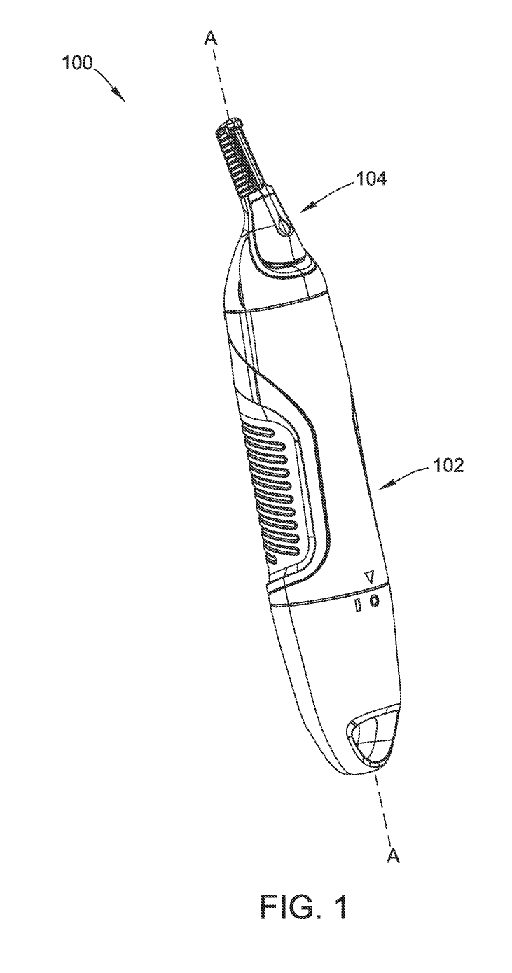

FIG. 1 is a perspective view of one embodiment of an electric hair trimmer;

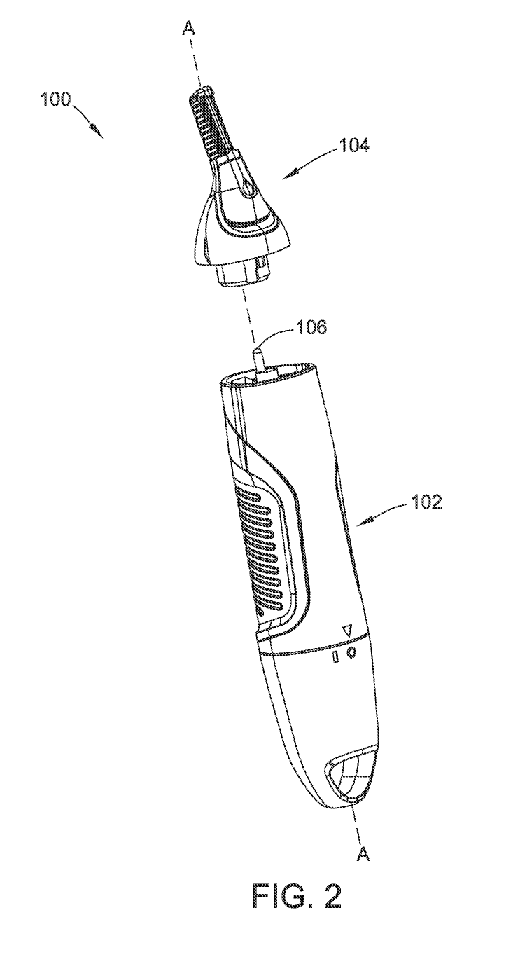

FIG. 2 is a partially exploded view of the trimmer of FIG. 1;

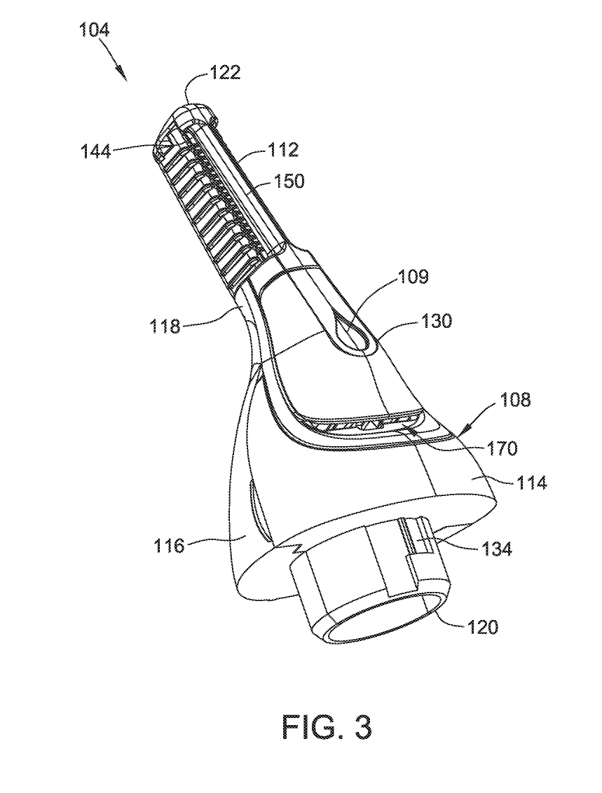

FIG. 3 is perspective view of a head of the trimmer of FIG. 1;

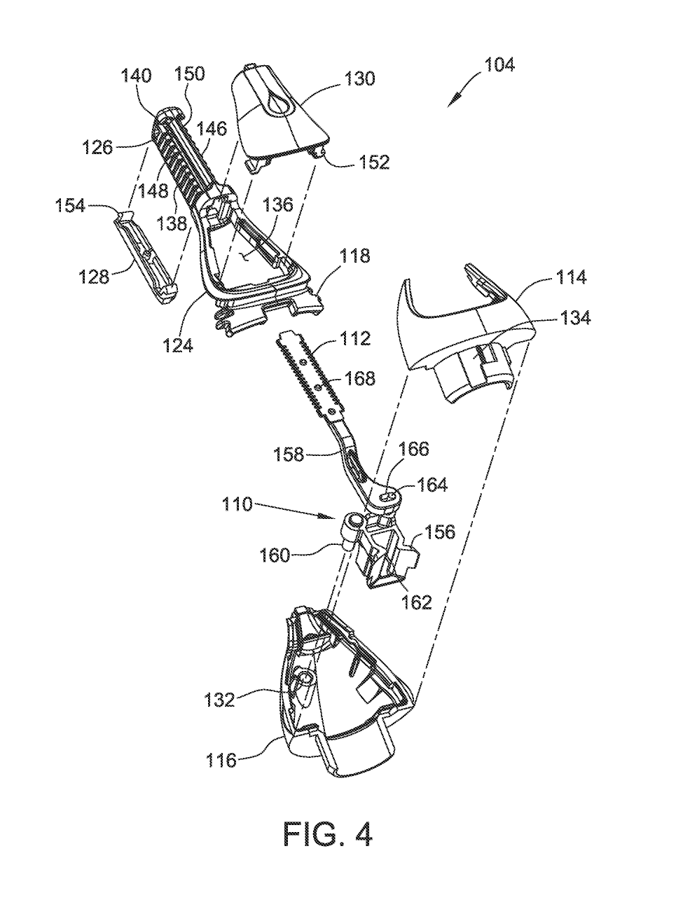

FIG. 4 is an exploded view of the head of FIG. 3;

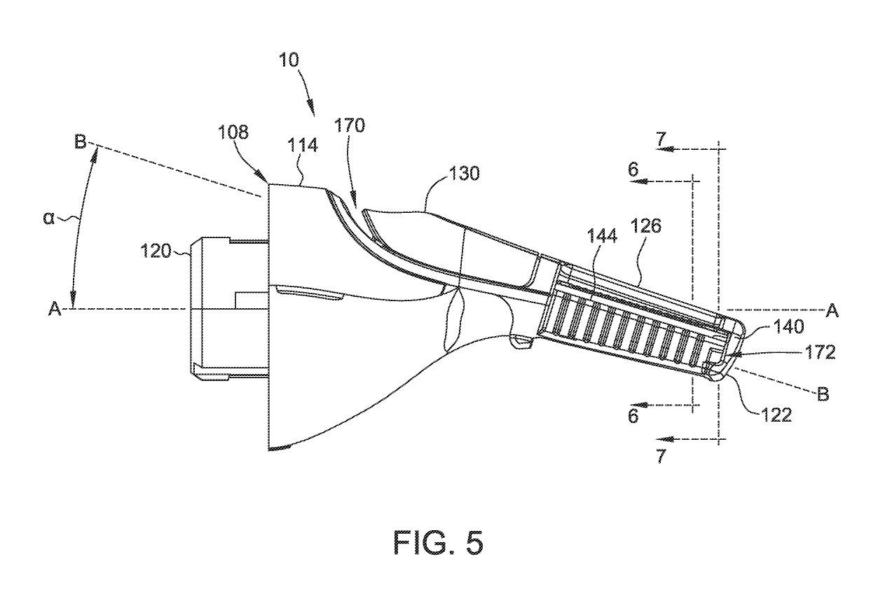

FIG. 5 is a side view of a housing of the head of FIG. 3;

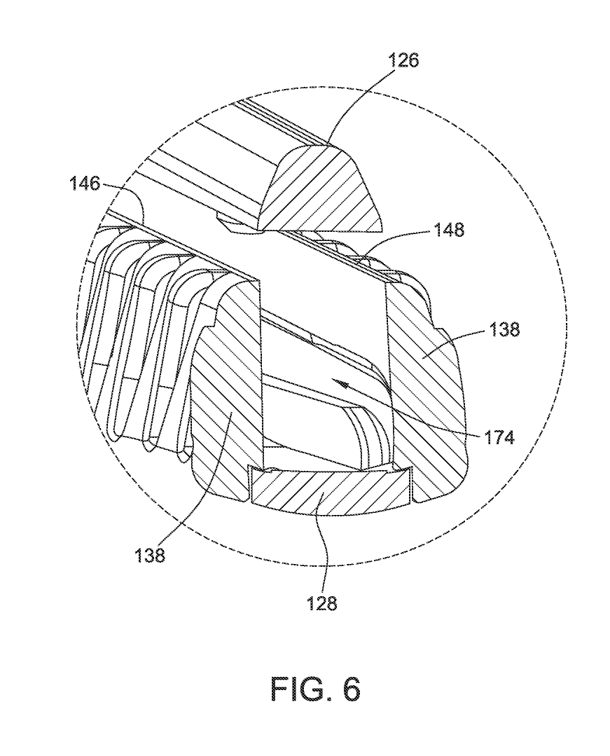

FIG. 6 is an enlarged perspective view of a cross-section of the housing of FIG. 5 taken along plane 6-6;

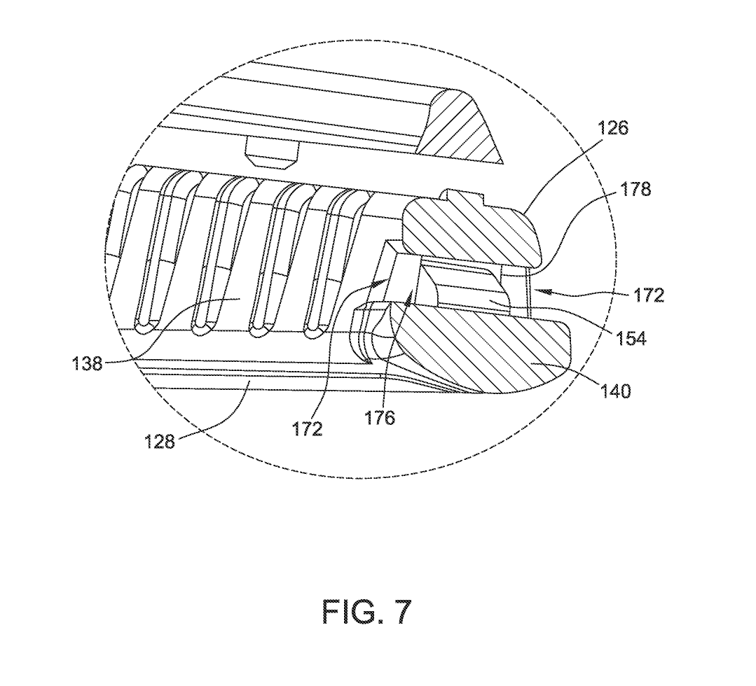

FIG. 7 is an enlarged perspective view of a cross-section of the housing of FIG. 5 taken along plane 7-7;

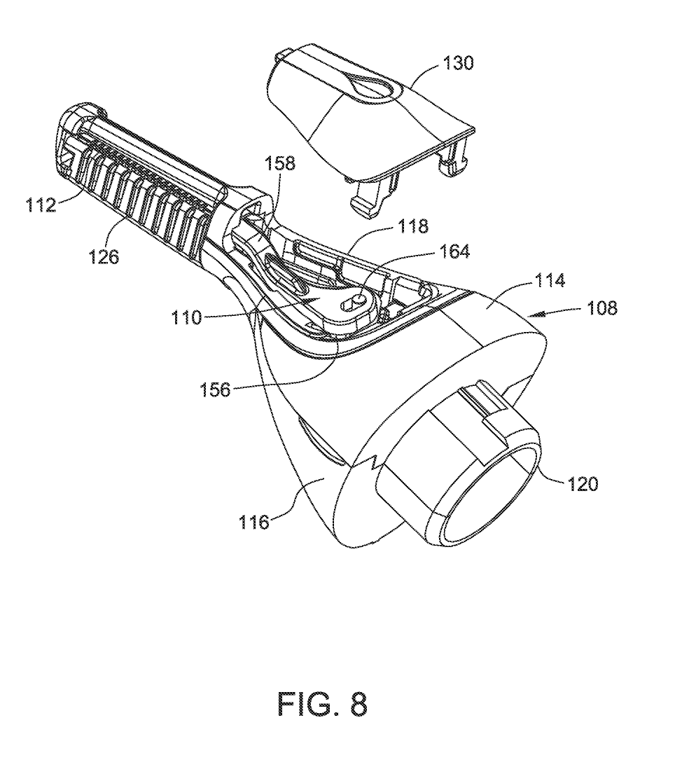

FIG. 8 is a partially exploded view of the head of FIG. 3;

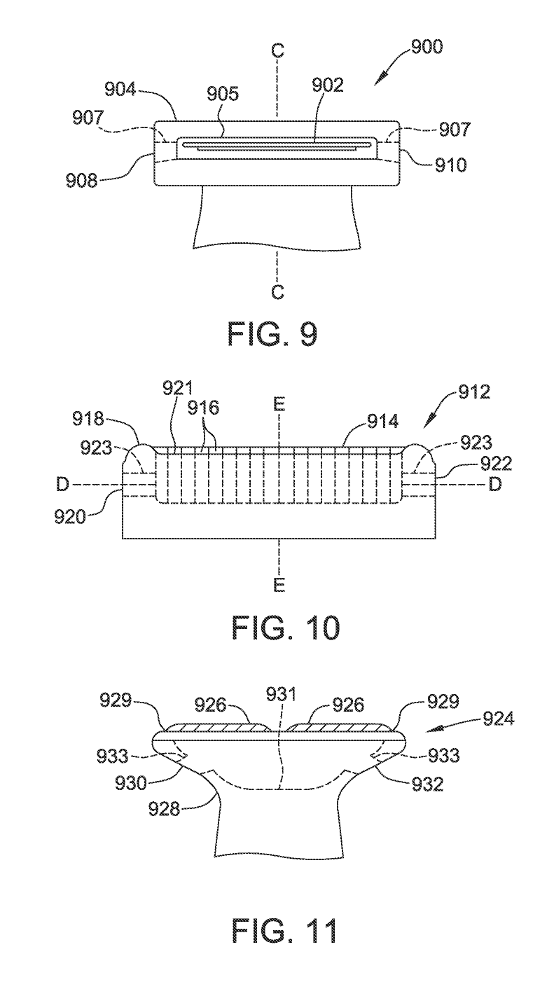

FIG. 9 is another embodiment of a trimmer head having washout features similar to the head of FIGS. 3-8 and configured for use with the handle of FIGS. 1 and 2;

FIG. 10 is an embodiment of an epilator head having washout features similar to the head of FIGS. 3-8 and configured for use with the handle of FIGS. 1 and 2; 1

FIG. 11 is an embodiment of a shaver head having washout features similar to the head of FIGS. 3-8 and configured for use with the handle of FIGS. 1 and 2;

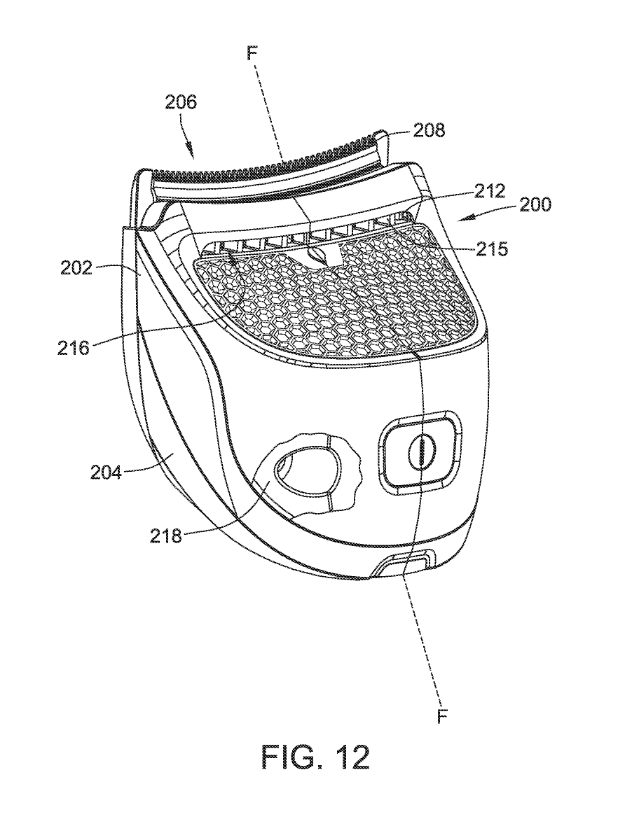

FIG. 12 is a perspective view of another embodiment of an electric hair trimmer with a portion of a housing removed to show the interior of the trimmer;

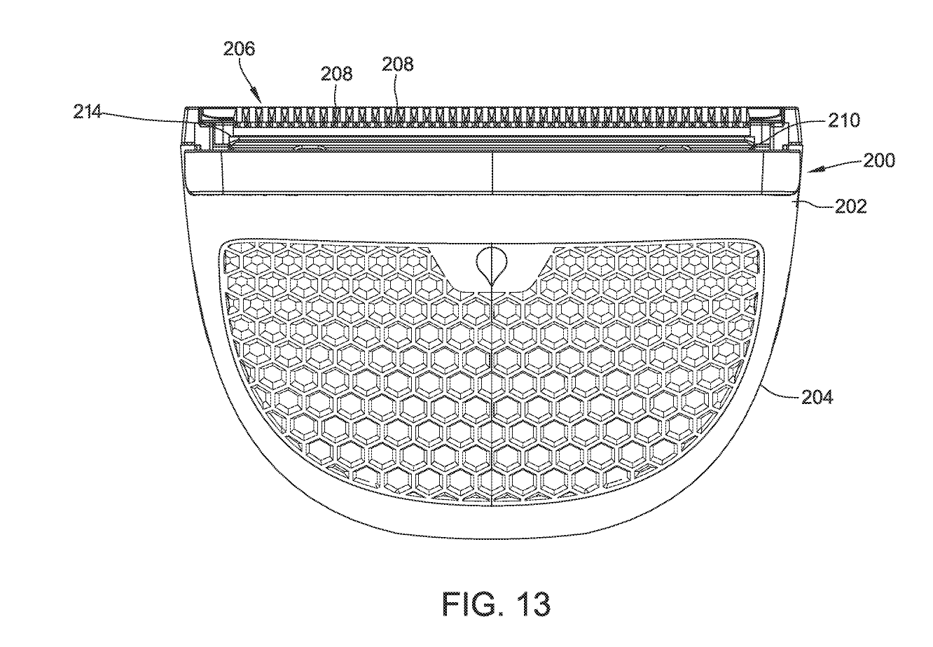

FIG. 13 is a top view of the trimmer of FIG. 12;

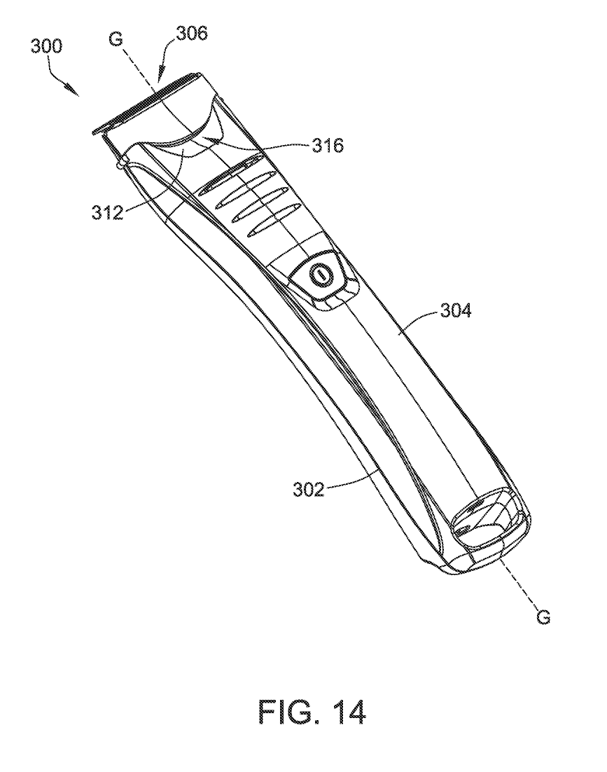

FIG. 14 is a perspective view of an embodiment of an electric hair clipper; and

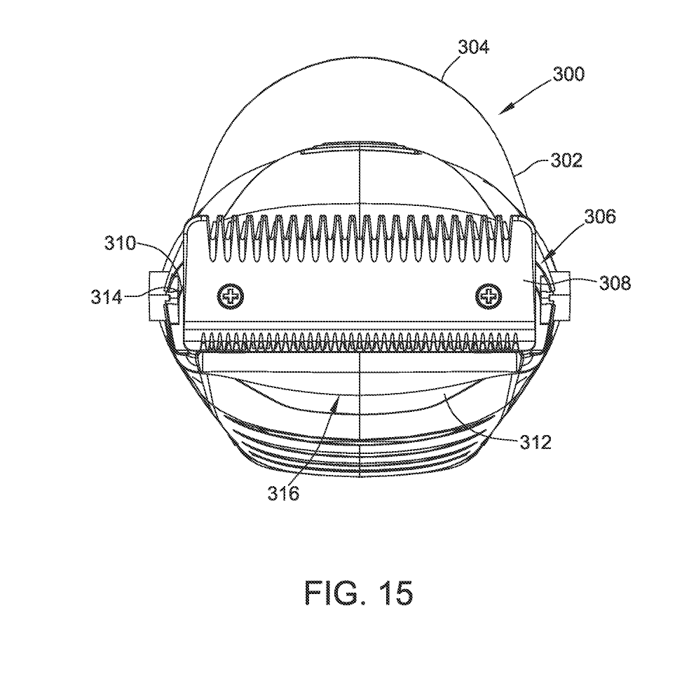

FIG. 15 is a top view of the clipper of FIG. 14.

Corresponding reference characters indicate corresponding parts throughout the several views of the drawings.

### DETAILED DESCRIPTION

Referring now to the drawings, and in particular to FIGS. 1 and 2, an electric hair trimmer (broadly a grooming appliance) is indicated generally by 100. The illustrated trimmer 100 comprises a handle (indicated generally by 102) and a head (indicated generally by 104). The head 104 is operably connected to a motor of the handle 102 by virtue of a drive mechanism (e.g., an eccentric drive pin 106) such that the trimmer 100 has a longitudinal axis A-A. In the illustrated embodiment, the head 104 is detachable from the handle 102. In other embodiments, however, the head 104 may be operable using any suitable drive mechanism of the handle 102, and the head 104 may not be detachable from the handle 102.

With reference now to FIGS. 3 and 4, the head 104 includes a housing (indicated generally by 108), a drive assembly (indicated generally by 110), and a blade assembly 112. The drive assembly 110, and part of the blade assembly 112, are contained within the housing 108 such that cutting edge(s) of the blade assembly 112 are exposed for trimming hair using the blade assembly 112. The housing 108 includes a front shell 114, a back shell 116 fastened to the front shell 114, and a frame 118 extending from the shells 114, 116 such that the housing 108 has a proximal end 120 and a distal end 122. The frame 118 has a base segment 124 secured between the shells 114, 116, a guard segment 126 extending from the base segment 124, a back panel 128 connected to the guard segment 126, and a front panel 130 connected to the base segment 124.

A post hole 132 is defined on the interior of the back shell 116, and a keyway 134 is defined on the exterior of the front shell 114. The base segment 124 is generally horseshoe-shaped and defines a window 136, and the guard segment 126 includes a pair of spaced-apart side walls 138 and an end wall 140. The side walls 138 extend from the base segment 124, and the end wall 140 extends between the side walls 138 opposite the base segment 124 such that the side walls 138 and the end wall 140 surround the blade assembly 112. Moreover, a back opening (not shown) and a front opening 144 provide access to the interior of the guard segment 126 as set forth in more detail below. The front opening 144 is bifurcated into a first blade slot 146 and a second blade slot 148 by a rib 150 that extends between the end wall 140 and the base segment 124.

In the illustrated embodiment, the front panel 130 has a plurality of flexible clips 152, and the back panel 128 has a plurality of flexible clips 154. In this manner, the front panel 130 is attached to the base segment 124 to cover the window 136, and the back panel 128 is attached to the guard segment 126 to cover the back opening (not shown). However, these flexible clips 152, 154 are not intended to render the panels 128, 130 removable but, rather, the font panel 130 and the back panel 128 are configured to be permanently fixed in place once attached to the base segment 124 and the guard segment 126, respectively. In other embodiments, the front panel 130 and/or the back panel 128 may be configured (e.g., the flexible clips 152, 154 may be configured) for removable attachment to the base segment 124 and the guard segment 126, respectively.

The drive assembly 110 and the blade assembly 112 are mounted within the housing 108, and the drive assembly 110 includes a follower 156, a linkage 158, and a pivot post 160. The pivot post 160 is seated within the post hole 132 so as to connect the drive assembly 110 to the housing 108. The follower 156 is pivotable about the pivot post 160, and the follower 156 has a winged slot 162 and a linking pin 164. The linkage 158 is a generally linear arm having, at opposing ends of the arm, a linking slot 166 and a plurality of locator pins 168. The linking slot 166 receives the linking pin 164 of the follower 156, and the winged slot 162 of the follower 156 receives the drive pin 106 of the handle 102. The blade assembly 112 includes a plurality of toothed blades arranged in shearing, face-to-face contact with one another, and at least one of the blades is seated on the locator pins 168 of the linkage 158.

During operation of the trimmer 100, the eccentric drive pin 106 is rotated (e.g., via a drive shaft of a motor contained within the handle 102), and the follower 156 pivots back-and-forth (in a pendulum-like manner) about the pivot post 160 by virtue of the rotating eccentric drive pin 106 being disposed within the winged slot 162 of the follower 156. Because the linking pin 164 of the follower 156 is inserted into the linking slot 166 of the linkage 158, the back-and-forth pivoting movement of the follower 156 about the pivot post 160 causes a back-and-forth linear movement (or translatory motion) of the linkage 158. With the blade assembly 112 (e.g., a movable blade of the blade assembly 112) being seated on the linkage 158 via the locator pins 168, the blade assembly 112 is actuated by the linear movement of the linkage 158, thereby reciprocating the blades to shear off hairs that enter the gaps between the teeth of the blades.

Referring now to FIGS. 5-7, the housing 108 also includes a plurality of washout ports that permit fluid flow into and/or out of the housing 108, namely a first (or inlet) washout port (indicated generally by 170) and a pair of second (or outlet) washout ports (indicated generally by 172).

In the illustrated embodiment, the first washout port 170 and the second washout ports 172 are in flow communication with one another across an internal flow path (indicated generally by 174) of the housing 108. The first washout port 170 is positioned at a location along the longitudinal axis A-A that is between the proximal end 120 of the housing 108 and the front opening 144 of the housing 108. The pair of second washout ports 172 are positioned at locations along the longitudinal axis A-A that are between the distal end 122 of the housing 108 and the first washout port 170. In some embodiments, the second washout ports 172 may be positioned along the longitudinal axis A-A so as to be partly (or wholly) aligned with a portion of the front opening 144, as shown in FIG. 5. Alternatively, in other embodiments, the first washout port 170 may be any suitable number of similarly functioning first washout ports, and the second washout ports 172 may be any suitable number of similarly functioning second washout ports (e.g., the first washout port 170 may alternatively be a pair of first washout ports, and the second washout ports 172 may alternatively be a single second washout port).

The first washout port 170 is located on one side of the longitudinal axis A-A (e.g., above the longitudinal axis A-A when the first washout port 170 is facing upward as shown in FIG. 5), and the second washout ports 172 are located on the opposite side of the longitudinal axis A-A (e.g., below the longitudinal axis A-A when the first washout port 170 is facing upward as shown in FIG. 5). Thus, the internal flow path 174 extends from the first washout port 170 toward the second washout ports 172 along a flow axis B-B that is oblique to the longitudinal axis A-A at an acute angle α. More specifically, when the first washout port 170 is facing upward as shown, the flow axis B-B is angled downward from the first washout port 170 to the second washout ports 172. Optionally, the flow axis B-B may be linear (as shown) or curvilinear. Of particular note, in the illustrated embodiment, the blade(s) of blade assembly 112 reciprocate along the flow axis B-B (i.e., generally along the longitudinal axis A-A). In alternate embodiments, the blade(s) may reciprocate in any direction, e.g., a direction perpendicular to the longitudinal axis A-A and/or the flow axis B-B.

The internal flow path 174 is defined, along a region of its lower boundary, by the back panel 128, and, along a region of its side boundaries, by the side walls 138. In this manner, the internal flow path 174 is in flow communication with the front opening 144, namely with the first blade slot 146 and the second blade slot 148. Notably, the internal flow path 174 may be a plurality of internal flow paths in other embodiments (e.g., the internal flow path 174 may include one or more flow-axial partitions that segment the internal flow path 174 into multiple different internal flow paths).

In the illustrated embodiment, the first washout port 170 is elongate and extends generally transversely of the housing 108. The illustrated first washout port 170 is generally crescent-shaped, and is defined between the front panel 130 and the front shell 114. In other embodiments, however, the first washout port 170 may be any suitable shape defined by any suitable structures of the housing 108. Furthermore, in the illustrated embodiment, each of the second washout ports 172 is generally box-shaped and is located on one of the side walls 138 near the end wall 140. As such, the second washout ports 172 are near the distal end 122 of the housing 108. In other embodiments, the second washout ports 172 may be any suitable shape and may be located in any suitable place on the handle 102 or the head 104 that facilitates enabling the second washout ports 172 to function as described herein. Moreover, the first washout port 170 may be located in any suitable place on the handle 102 or the head 104 that facilitates enabling the first washout port 170 to function as described herein (e.g., if the first washout port 170 and/or the second washout ports 172 were located on the bottom or side of the handle 102, the internal flow path 174 would suitably extend from the handle 102 into the head 104 (and possibly back into the handle 102) so as to be in flow communication with the front opening 144 as described herein).

Optionally, the housing 108 may include a visual indicator to signal to a user the location and function of the first washout port 170 and/or the second washout port 172. For example, in the illustrated embodiment, the front panel 130 has a visual indicator 109 including a representation of a water drop disposed adjacent the first washout port 170. The visual indicator 109 can remind a user to clean the trimmer 100 after use by directing fluid into the first washout port 170.

The second washout ports 172 are connected in flow communication with one another via a flow path branch (indicated generally by 176). The branch 176 is located near the distal end 122 of the housing 108 internal to the end wall 140, and the branch 176 is in flow communication with the internal flow path 174 via an aperture 178 (which, in the illustrated embodiment, is partially occluded by one of the flexible clips 154 of the back panel 128). In this manner, the branch 176 extends substantially perpendicular to the flow axis B-B of the internal flow path 174. In other embodiments, the branch 176 may be connected in flow communication with the internal flow path 174 in any suitable manner. Alternatively, the housing 108 may not have the branch 176 but, rather, may have the second washout port(s) 172 connected in direct flow communication with the internal flow path 174 (i.e., fluid flowing along the internal flow path 174 may not have to change direction prior to being drained from the housing 108 via the second washout port(s) 172).

Referring to FIG. 8, when the drive assembly 110 and the blade assembly 112 are disposed within the housing 108, the follower 156 is disposed at least in part between the shells 114, 116 such the winged slot 162 (FIG. 4) is accessible via the open proximal end 120 of the housing 108. As such, the linkage 158 and the linking pin 164 are aligned with the window 136 (FIG. 4), with the linkage 158 extending into the guard segment 126 along the internal flow path 174 (FIG. 6) such that the blade assembly 112 is exposed through the blades slots 146, 148 (FIG. 6). In this manner, the front panel 130 is situated over the linking pin 164 when the front panel 130 is connected to the frame 118.

During operation of the trimmer 100, hair and other debris may collect in the guard segment 126 of the housing 108 (e.g., on the interior of the guard segment 126) and on the blade assembly 112. To clean the trimmer 100, a user simply directs a cleaning fluid (e.g., a liquid such as water or a suitable cleaning solution in the primary embodiment, or a compressed gas in other embodiments) from a spout into the first washout port 170 in a flow direction D (FIG. 5). If the longitudinal axis A-A is held substantially perpendicular to the flow direction D of the fluid as shown in FIG. 5, the flow axis B-B is oriented at a decline toward the second washout ports 172 such that the fluid tends to naturally flow from the first washout port 170, over the linkage 158, and down toward the second washout ports 172 via the force of gravity without the user having to alter the position of the handle 102 from its orientation of the longitudinal axis A-A being substantially perpendicular to the flow direction D of fluid from the spout. Upon reaching the end of the internal flow path 174, the fluid passes through the aperture 178 and enters the branch 176, at which point the flow of fluid sharply changes direction toward the second washout ports 172 to be drained from the housing 108 via the second washout ports 172. As the fluid flows through the internal flow path 174, the fluid cleans the interior of the guard segment 126.

In the illustrated embodiment, the first washout port 170 and the second washout ports 172 are substantially uncovered to facilitate the user cleaning the trimmer 100 as described herein without having to uncover the ports. Optionally, the first washout port 170 and/or the second washout ports 172 may each be configured with a closure (e.g., a manually movable wall, a flexible gasket, or a suitable valve) that enables the first washout port 170 and/or the second washout ports 172 to be opened only during cleaning, and otherwise closed.

Moreover, because the internal flow path 174 is in flow communication with the front opening 144, the cleaning fluid is able to be discharged from the housing 108 through the front opening 144 via the first blade slot 146 and the second blade slot 148. Specifically, the first washout port 170 and the internal flow path 174 both have cross-sectional areas (measured perpendicular to the flow axis B-B) that are larger than the unobstructed space of the aperture 178, being that the aperture 178 is partially occluded by one of the clips 154 of the back panel 128. As such, there tends to be a natural bottleneck of fluid at the aperture 178, which causes the level of fluid within the internal flow path 174 to rise until the fluid is forced out of the first blade slot 146 and the second blade slot 148. As the fluid is forced out of the first blade slot 146 and the second blade slot 148, the fluid passes through the teeth of blade assembly 112, thereby cleaning blade assembly 112. Optionally, the blade assembly 112 may be cleaned when active or inactive (i.e., when the trimmer 100 is ON or OFF). In the event that the blade assembly 112 is actuated (i.e., the trimmer is ON) while the fluid is exiting the housing 108 via the first blade slot 146 and the second blade slot 148, the teeth of the blade assembly 112 will agitate the fluid to essentially froth the fluid for enhancing the cleaning process.

In one contemplated embodiment, the head (whether detachable from the handle or not) may be a trimmer head (indicated generally at 900) (FIG. 9) having toothed blades 902 partially contained within a housing 904 and exposed through an opening 905 in the housing 904. At least one of the blades 902 is oriented to reciprocate substantially perpendicular to the longitudinal axis C-C of the appliance. The housing 904 has a first washout port (or inlet port) 908, a second washout port (or outlet port) 910, and an internal flow path 907 that connects the first washout port 908, the second washout port 910, and the opening 905 in flow communication with one another for cleaning the blades 902 and/or the interior of the housing 904 as set forth above.

In another contemplated embodiment, the head (whether detachable from the handle or not) may be an epilator head (indicated generally at 912) (FIG. 10) having a rotatable barrel 914 with hair plucking discs (or plates) 916 affixed thereto. The barrel 914 is rotatable about a rotational axis D-D that is substantially perpendicular to a longitudinal axis E-E of the appliance, and the barrel 914 is partially contained within a housing 918 and exposed through an opening 921 in the housing 918. The housing 918 has a first washout port (or inlet port) 920, a second washout port (or outlet port) 922, and an internal flow path 923 that connects the first washout port 920, the second washout port 922, and the opening 921 in flow communication with one another for cleaning the barrel 914 and/or the interior of the housing 918 as set forth above.

In yet another contemplated embodiment, the head (whether detachable from the handle or not) may be a foil or rotary shaver head (indicated generally at 924) (FIG. 11) having at least one blade unit 926 partially contained within a housing 928 and exposed through at least one opening 929 in the housing 928. The housing 928 has a hair pocket 931 that collects hair cut by the blade unit(s) 926. The housing 928 also has a first washout port (or inlet port) 930, a second washout port (or outlet port) 932, and an internal flow path 933 that connects the first washout port 930, the second washout port 932, and the opening(s) 929 in flow communication with one another across the hair pocket 931 for cleaning the blade unit(s) 926 and/or the interior of the housing 928 as set forth above.

FIGS. 12-13 illustrate a grooming appliance in the form of an electric hair trimmer indicated generally by 200. The illustrated trimmer 200 comprises a housing 202 and a blade assembly 206. The housing 202 has a handle 204 defining a longitudinal axis F-F. The blade assembly 206 is operably connected to a motor of the handle 204 by virtue of a conventional drive mechanism (not shown). The blade assembly 206 is at least partially exposed through an opening 210 in the housing 202 and includes toothed blades 208. At least one of the blades 208 is oriented to reciprocate in a direction substantially perpendicular to the longitudinal axis F-F of the trimmer 200. In suitable embodiments, the blades 208 may have any shape, such as a substantially straight shape. In the illustrated embodiment, the blades 208 have a curved shape.

The housing 202 has a first washout port (or inlet port) 212, a second washout port (or outlet port) 214, and an internal flow path 216 that connects the first washout port 212, the second washout port 214, and the opening 210 in flow communication with one another for cleaning the blades 208 and/or the interior of the housing 202. In suitable embodiments, the first washout port 212 and the second washout port 214 may comprise any number of openings of any size and shape. In the example embodiment, the first washout port 212 has an elongated slot shape and includes a plurality of guards 215 to inhibit objects from entering the interior of the housing 202 through the first washout port and contacting the drive assembly.

Fluid enters the interior of the housing 202 through the first washout port 212 and flows through the interior to remove debris from the interior. A water-resistant casing 218 encloses the motor of the trimmer 200 to prevent fluid from damaging the motor when fluid flows through the interior of the housing 202. Fluid and debris flow out of the interior of the housing 202 through the second washout port 214 and opening 210.

FIGS. 14-15 illustrate a grooming appliance in the form of an electric hair clipper indicated generally by 300. The illustrated clipper 300 comprises a housing 302 and a blade assembly 306. The housing has a handle 304 defining a longitudinal axis G-G. The blade assembly 306 is operably connected to a motor of the handle 304 by virtue of a conventional drive mechanism (not shown). The blade assembly 306 is at least partially exposed through an opening 310 in the housing 302 and includes toothed blades 308. At least one of the blades 308 is oriented to reciprocate in a direction substantially perpendicular to the longitudinal axis C-C of the clipper 300.

The housing 302 has a first washout port (or inlet port) 312, a second washout port (or outlet port) 314, and an internal flow path 316 that connects the first washout port 312, the second washout port 314, and the opening 310 in flow communication with one another for cleaning the blades 308 and/or the interior of the housing 302 as set forth above. The second washout port 314 is disposed in the housing adjacent at least a portion of the blades 308. In the example embodiment, the opening 310 at least partially forms the second washout port 314. As a result, when fluid flows out of the interior of the housing 302 through the second washout port 314, the fluid strikes the blades 308.

In some alternative embodiments, the internal flow path(s) and/or the washout port(s) described above may facilitate servicing the blades with, for example, a lubricant such as oil or grease (in lieu of, or in addition to, being used for cleaning purposes as set forth herein). Moreover, in other alternative embodiments, the internal flow path(s) and/or the washout port(s) described above may facilitate delivering a shaving aid such as foam or gel to the skin during a grooming operation (in lieu of, or in addition to, being used for cleaning purposes as set forth herein).

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. An electric trimmer comprising:
a handle;
a motor housed within the handle; and
a trimmer head extending at least in part longitudinally from the handle, the trimmer head comprising a housing and an elongate blade assembly retained by the housing, the blade assembly including at least one reciprocating blade operatively connected to the motor and oriented for reciprocating at least in part longitudinally, the trimmer head housing having an inlet port through which cleaning fluid can enter the housing other than between the blade assembly and the housing, the housing defining an internal flow path in flow communication with the inlet port and extending at least in part longitudinally of the housing for directing fluid to flow at least in part longitudinally within the housing.

2. The electric trimmer of claim 1 wherein the blade assembly is in communication with the internal flow path defined by the housing to permit cleaning fluid flowing within the housing to contact the blade assembly for cleaning the blade assembly.

3. The electric trimmer of claim 2 wherein the inlet port is elongate and extends generally transversely of the housing.

4. The electric trimmer of claim 1 wherein the housing further has an outlet port in flow communication with the internal flow path defined by the housing to permit at least some cleaning fluid flowing within the house to exit the housing other than between the blade assembly and the housing.

5. The electric trimmer of claim 4 wherein the housing has a pair of outlet ports spaced from each other and from the inlet port and being in flow communication with the internal flow path of the housing.

6. The electric trimmer of claim 1 wherein the housing has a blade slot through which the blade is exposed.

7. The electric trimmer of claim 6 wherein the inlet port and the blade slot are in flow communication with the outlet port across an aperture sized to be a bottleneck for fluid flowing along the internal flow path from the inlet port toward the outlet port so as to direct some cleaning fluid to exit the housing at the blade slot.

8. The electric trimmer of claim 1 wherein the housing has a proximal end adjacent the handle and a distal end, the inlet port being disposed nearer to the proximal end of the housing than the outlet port.

9. The electric trimmer of claim 8 wherein the outlet port is adjacent the distal end of the housing.

10. A detachable trimmer head for an electric trimmer having a handle that contains a motor, said detachable head comprising:
an elongate housing connectable to the handle to extend longitudinally from the handle, and an elongate blade assembly retained by the housing and extending lengthwise thereof, the blade assembly including at least one reciprocating blade operatively connected to the motor and oriented for reciprocating at least in part longitudinally of the housing, the housing having an inlet port through which cleaning fluid can enter the housing other than between the blade assembly and the housing, the housing defining an internal flow path in flow communication with the inlet port and extending at least in part longitudinally of the housing for directing fluid to flow at least in part longitudinally within the housing.

11. The electric trimmer of claim 10 wherein the blade assembly is in fluid communication with the internal flow path defined by the housing to permit cleaning fluid flowing within the housing to contact the blade assembly for cleaning the blade assembly.

12. The electric trimmer of claim 11 wherein the inlet port is elongate and extends generally transversely of the housing.

13. The electric trimmer of claim 10 wherein the housing further has an outlet port in flow communication with the internal flow path defined by the housing to permit at least some cleaning fluid flowing within the house to exit the housing other than between the blade assembly and the housing.

14. The electric trimmer of claim 10 wherein the housing has a blade slot through which the blade is exposed.

15. The electric trimmer of claim 14 wherein the inlet port and the blade slot are in flow communication with the outlet port across an aperture sized to be a bottleneck for fluid flowing along the internal flow path from the inlet port toward the outlet port so as to direct some cleaning fluid to exit the housing at the blade slot.

16. The electric trimmer of claim 10 wherein the housing has a proximal end for disposition adjacent the handle upon connection thereto and a distal end, the inlet port being disposed nearer to the proximal end of the housing than the outlet port.

17. The electric trimmer of claim 16 wherein the outlet port is adjacent the distal end of the housing.

18. The electric trimmer of claim 13 wherein the housing has a pair of outlet ports spaced from each other and from the inlet port and being in flow communication with the internal flow path of the housing.

19. A method of cleaning an ear and nose trimmer, the trimmer having an elongate trimmer head extending longitudinally from a handle, the trimmer head having a housing including a proximal end adjacent to the handle and a distal end longitudinally spaced from the handle, and an elongate blade assembly retained by and extending between the proximal and distal ends of the housing, the method comprising:
directing cleaning fluid to flow into an interior of the trimmer head housing adjacent the proximal end of the housing and other than between the blade assembly and the housing;
directing the cleaning fluid to flow along an internal flow path within the interior of the trimmer head housing from the proximal end toward the distal end of the housing;
directing at least some cleaning fluid to flow outward of the housing between the blade assembly and the housing to thereby clean the blade assembly; and
directing the remaining cleaning fluid to flow outward of the housing at the distal end of the housing other than between the blade assembly and the housing.

20. The method set forth in claim 19 wherein directing cleaning fluid to flow into an interior of the trimmer head housing adjacent the proximal end of the housing and other than between the blade assembly and the housing generally comprises orienting the trimmer in a generally inverted orientation such that an inlet port disposed at the proximal end of the housing faces generally upward for receiving cleaning fluid into the housing and allowing the cleaning fluid to flow downward within the housing toward the distal end of the housing.

21. An electric grooming appliance comprising:
a handle;
a motor housed within the handle; and
a head extending from the handle, the head comprising a housing, a hair removal device contained partially within the housing, and an opening in the housing through which the hair removal device is exposed for removing hair, the hair removal device including at least one movable hair removing member,
wherein an inlet port and an outlet port are each defined on one of the head and the handle, and wherein an internal flow path extends from the inlet port to the outlet port in flow communication with the opening such that a cleaning fluid can flow through the internal flow path to clean the hair removal device by entering and exiting the appliance other than through the opening by which the hair removal device is exposed.

22. The electric grooming appliance of claim 21 wherein the hair removal device is a toothed trimmer blade assembly.

23. The electric grooming appliance of claim 22 wherein the appliance has a longitudinal axis, and at least one of the hair removing members is oriented for reciprocating at least in part longitudinally.

24. The electric grooming appliance of claim 22 wherein the appliance has a longitudinal axis, and at least one of the hair removing members is oriented for reciprocating in a direction substantially perpendicular to the longitudinal axis.

25. The electric grooming appliance of claim 21 wherein the hair removal device is a rotatable epilator barrel.

26. The electric grooming appliance of claim 21 wherein the hair removal device is a shaver blade unit.

27. The electric grooming appliance of claim 21 wherein the inlet port, the outlet port, and the internal flow path are configured to facilitate servicing the hair removal device with a lubricant.

28. The electric grooming appliance of claim 21 wherein the inlet port, the outlet port, and the internal flow path are configured to facilitate delivering a shaving aid to the skin during a grooming operation.
